(19) United States
(12) Patent Application Publication
(10) Pub. No.: US 2023/0421357 A1
(43) Pub. Date: Dec. 28, 2023

(54) METHOD AND SYSTEM FOR ANONYMOUS SYMMETRIC AUTHENTICATED KEY ESTABLISHMENT

(71) Applicant: NEC Laboratories Europe GmbH, Heidelberg (DE)

(72) Inventor: Claudio Soriente, Heidelberg (DE)

(21) Appl. No.: 17/891,217

(22) Filed: Aug. 19, 2022

Related U.S. Application Data
(60) Provisional application No. 63/350,501, filed on Jun. 9, 2022.

(51) Int. Cl. H04L 9/08; H04L 9/14; H04L 9/06

(52) U.S. Cl. CPC H04L 9/0819; H04L 9/0618; H04L 9/14; H04L 9/0869

(57) ABSTRACT

A method for providing anonymous symmetric authenticated key establishment (ASAKE) is provided. The method includes a server encrypting an ephemeral secret using a broadcast encryption (BE) scheme to generate one or more ciphertexts. The method further includes the server providing the ciphertexts indicating the encrypted ephemeral secret to a client device. The method also includes the server executing a symmetric authenticated key establishment protocol (SAKE) with the client device based on using the ephemeral secret as a common secret.

### CROSS-REFERENCE TO PRIOR APPLICATION

Priority is claimed to U.S. Provisional Application No. 63/350,501 filed on Jun. 9, 2022, the entire contents of which is hereby incorporated by reference herein.

### FIELD

The present disclosure relates to a method, system and computer-readable medium for anonymous symmetric authenticated key establishment (ASAKE).

### BACKGROUND

Authenticated Key Exchange (AKE) allows two parties to authenticate and to agree on a symmetric key so that no eavesdropper or unauthorized party can learn the key. The two parties can then use the key to, e.g., establish a confidential and authenticated communication channel, by means of encryption and message authentication. In client-server settings such as internet-of-things (IoT) scenarios, AKE can be used for the client to authenticate to the server and, at the same time, establish a secure channel for the client to upload data. For instance, AKE protocols based on symmetric key primitives, also known as Symmetric AKE (SAKE), are especially relevant for IoT devices with limited computing resources. Further, SAKE protocols can provide quantum security, if parameters of the undelaying symmetric primitives are chosen carefully.

Privacy-preserving SAKE protocols can be designed where identities of the participating parties are not revealed to eavesdroppers or unauthorized parties. However, while the identities of participating parties (e.g., clients) are not revealed to eavesdroppers, in traditional SAKE implementations for the client-server settings, the identity of the client is revealed to the server, which may cause drawbacks if the client seeks to be anonymous to the server. Furthermore, alternative cryptographic primitives that allow a client to authenticate to a server while keeping the client's identity private exist (e.g., group signatures or ring signatures); however, such alternatives are based on public-key cryptography and not SAKE protocols. Therefore, these public-key cryptography implementations are not suited for resource-constrained devices such as IoTs.

### SUMMARY

In an embodiment, the present invention provides a method for providing anonymous symmetric authenticated key establishment (ASAKE). The method includes the steps of: encrypting, by a server, an ephemeral secret using a broadcast encryption (BE) scheme to generate one or more ciphertexts; providing, by the server, the ciphertexts indicating the encrypted ephemeral secret to a client device; and executing, by the server, a symmetric authenticated key establishment protocol (SAKE) with the client device based on using the ephemeral secret as a common secret.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a simplified block diagram depicting an exemplary computing environment according to an embodiment of the present invention;

FIG. 2 illustrates an event sequence for an ASAKE protocol for a server to authenticate a client and agree on a common symmetric key according to an embodiment of the present invention;

FIG. 3 illustrates a process for computing encryption keys, producing a bitmask to encrypt messages, and verify ciphertext using an ASAKE protocol according to an embodiment of the present invention; and

FIG. 4 is a block diagram of an exemplary processing system according to an embodiment of the present invention.

### DETAILED DESCRIPTION

Aspects of the present disclosure provide an anonymous SAKE (ASAKE), which is an anonymous SAKE protocol for the client-server settings where clients authenticate to a server so that the client and the server establish a symmetric key but, at the same time, the identity of the client is unknown to the server. For instance, the present disclosure provides an anonymous authenticated key exchange protocol. In the client-server settings, clients can authenticate to the server and establish a symmetric key, while hiding their identity among the identities of all registered clients. For example, the server may learn (e.g., determine) whether the other party is a registered client, but cannot tell (e.g., determine) the client's actual identity (e.g., from among the identities of all registered clients). In some instances, the ASAKE protocol leverages symmetric-key primitives; and thus, the ASAKE protocol is suitable for (e.g., may be used by) resource-constrained devices and can achieve quantum security.

The ASAKE protocol provided in the present disclosure provides improvements to the field of AKE. For example, ASAKE protocols implemented according to aspects of the present disclosure provide for improved client anonymity, while efficiently using computing resources (as compared to alternatives). For example, compared to SAKE, ASAKE provided by the present disclosure provides client anonymity (e.g., a client ID is hidden from the server). Also, compared to anonymous authentication primitives (e.g., group signatures or ring signatures), ASAKE uses less computing resources, which are especially relevant for IoT devices, which have limited computing resources available. In some instances, the efficiency may be achieved by using solely symmetric-key primitives, whereas many AKE protocols are based on public-key cryptography.

In some variations, implementations of the ASAKE protocol provided according to the present disclosure are, therefore, particularly suited for client-server application scenarios where clients have constrained computing resources and a balance between anonymity and authentication may be needed. For instance, in some examples, the ASAKE protocol provided according to the present disclosure may be used in a smart-city scenario/example where registered IoT devices can upload anonymous measurements to a server related to, e.g., household energy consumption, or mobility traces. In some variations, in application scenario, an ASAKE protocol according to the present disclosure may provide improvements in privacy-preserving blockchains where nodes send their transactions to mixing servers. The latter (e.g., mixing servers) may only admit registered clients to submit their transactions. However, in some instances, the clients may seek to remain anonymous with respect to the mixing server. As such, the ASAKE protocol may be used.

According to one or more aspects of the present disclosure, a method is provided, the method including at least one of:
1. Computing the encryption keys of a symmetric-key broadcast encryption scheme as the evaluation keys of a verifiable pseudo-random function and using the output of the verifiable pseudo-random function evaluated over random elements to produce a bitmask to encrypt one or more messages.
2. Verifying, based on the proof output by the evaluation of the verifiable pseudorandom function, that a ciphertext produced by the above step encrypts one or more given messages.

Additionally, and/or alternatively, according to an aspect of the present disclosure, a method is provided for authenticating clients, by a server, and agreeing on a symmetric key while keeping the client's identity hidden from the server. The method includes at least one of:
1) Encrypting, by the server, an ephemeral secret based on a broadcast encryption scheme and sending the ciphertexts to the alleged client.
2) Decrypting, by the client, one of the ciphertexts and verifying, by the client, that all of the ciphertexts sent by the server, encrypt the same ephemeral secret.
3) Executing, by the client and/or the server, a symmetric authenticated key establishment protocol by using the ephemeral secret as the common secret.

According to another aspect of the present disclosure, a device comprising one or more processors is provided, the device being configured to execute a method according to one of the described aspects of the present disclosure.

According to another aspect of the present disclosure, a non-transitory computer readable medium is provided, which comprises instructions stored thereon, which when executed by one or more processors cause for the execution of a method according to tone of the described aspects of the present disclosure.

In an embodiment, the present invention provides a method for providing anonymous symmetric authenticated key establishment (ASAKE), the method comprising: encrypting, by a server, an ephemeral secret using a broadcast encryption (BE) scheme to generate one or more ciphertexts; providing, by the server, the ciphertexts indicating the encrypted ephemeral secret to a client device; and executing, by the server, a symmetric authenticated key establishment protocol (SAKE) with the client device based on using the ephemeral secret as a common secret.

In an embodiment, the method further comprises: generating, by the server, a plurality of encryption keys based on a verifiable pseudo-random function (VRF) key generation algorithm, wherein encrypting the ephemeral secret is based on using the plurality of encryption keys.

In an embodiment, the method further comprises: generating, by the server, a plurality of verification keys based on the VRF key generation algorithm, wherein a security parameter is input into the VRF key generation algorithm to generate the plurality of verification keys and the plurality of encryption keys; wherein the plurality of verification keys are made public; and providing, by the server, a first subset of the plurality of encryption keys to the client device.

In an embodiment, encrypting the ephemeral secret using the BE scheme comprises: determining, by the server, a second subset of the plurality of encryption keys based on a set of authorized client devices, wherein the set of authorized client devices comprises the client device; determining, by the server, one or more random initialization vectors; and encrypting the ephemeral secret using the second subset of the plurality of encryption keys and the one or more random initialization vectors.

In an embodiment, encrypting the ephemeral secret using the second subset of the plurality of encryption keys and the one or more random initialization vectors comprises: inputting the second subset of the plurality of encryption keys and the one or more random initialization vectors into a VRF evaluation algorithm to determine an output of the VRF evaluation algorithm and a proof of the VRF evaluation algorithm; and generating the ciphertexts indicating the encrypted ephemeral secret based on using a bitmask and the output of the VRF evaluation algorithm.

In an embodiment, generating the ciphertexts using the bitmask and the output of the VRF evaluation algorithm comprises: using an exclusive OR statement for the ephemeral secret and the output of the VRF evaluation algorithm to generate the encrypted ephemeral secret.

In an embodiment, the ciphertexts comprises the encrypted ephemeral secret, the one or more random initialization vectors, and the proof of the VRF evaluation algorithm.

In an embodiment, the method further comprises: decrypting, by the client device, a ciphertext of the ciphertexts to determine the ephemeral secret, wherein the ciphertexts comprises the encrypted ephemeral secret, one or more random initialization vectors, and a server proof of an VRF evaluation algorithm; verifying, by the client device, that the ciphertexts are sent by the server; and encrypting, by the client device, the ephemeral secret determined from the ciphertexts. For instance, the client device may determine (e.g., check) that the ciphertexts encrypted the same ephemeral secret.

In an embodiment, decrypting the one or more of the ciphertexts to determine the ephemeral secret comprises: inputting an evaluation key, of a plurality of evaluation keys provided by the server, and a random initialization vector, of the one or more random initialization vectors, into the VRF evaluation algorithm to determine a client device proof of the VRF evaluation algorithm and an output of the VRF evaluation algorithm; and decrypting the encrypted ephemeral secret based on the ciphertext and the output of the VRF evaluation algorithm.

In an embodiment, decrypting the encrypted ephemeral secret is based on using an exclusive OR statement for the output of the VRF evaluation algorithm and encrypted ephemeral secret.

In an embodiment, verifying that the ciphertexts are sent by the server comprises: determining an output of the VRF evaluation algorithm based on using an exclusive OR statement for the ephemeral secret decrypted from the ciphertext and the encrypted ephemeral secret from the ciphertexts.

In an embodiment, verifying that the ciphertexts are sent by the server further comprises: inputting a verification key generated by the server, the random initialization vector, the output of the VRF evaluation algorithm, and the client device proof of the VRF evaluation algorithm into a VRF verification algorithm to determine a verification output of the VRF verification algorithm, and wherein executing the SAKE protocol between the server and the client device is based on the verification output.

In another embodiment, the present invention provides a system, comprising: a server configured to: encrypt an ephemeral secret using a broadcast encryption (BE) scheme to generate one or more ciphertexts; provide the ciphertexts indicating the encrypted ephemeral secret to a client device; and execute a symmetric authenticated key establishment protocol (SAKE) with the client device based on using the ephemeral secret as a common secret.

In an embodiment, the system further comprises a client device configured to: decrypt a ciphertext of the ciphertexts to determine the ephemeral secret, wherein the ciphertexts comprises the encrypted ephemeral secret, one or more random initialization vectors, and a server proof of an VRF evaluation algorithm; verify that the ciphertexts are sent by the server; and encrypt the ephemeral secret determined from the ciphertexts.

In a further embodiment, a tangible, non-transitory computer-readable medium having instructions thereon which, upon being executed by one or more processors, alone or in combination, provide for execution of a method according to any embodiment of the present invention.

Authenticated Key Exchange.

As described above, authenticated key exchange (AKE) allows two parties (e.g., two entities such as a client device and a server) to establish a common key that may be used, e.g., for authenticated and confidential communication. Symmetric-key AKE (SAKE) allows parties sharing a secret to establish a fresh cryptographic key, by using only symmetric-key cryptographic primitives. See, e.g., Gildas Avoine, Sebastien Canard, Loïc Ferreira: Symmetric-Key Authenticated Key Exchange (SAKE) with Perfect Forward Secrecy. CT-RSA 2020 (the entire contents of which are hereby incorporated by reference here). Common security properties of SAKE protocols include: entity authentication, key indistinguishability, and forward security, among others. In some examples, symmetric-key primitives may include block/stream ciphers and/or hash functions. In some variations, entity authentication may refer to one of the peers that corroborates the identity of the others. In some instances, regarding key indistinguishability, given two keys, one being random and another output by an execution of the protocol, an adversary cannot tell which key is the one output by the protocol. As such, the probability of guessing correctly is essentially bounded by ½ plus some negligible value, where ½ is the probability of guessing correctly by outputting a random answer. Regarding forward security, compromise of one of the peers at a given point in time does not jeopardize the security (e.g., confidentially) of the keys established via protocol execution that ended before the peer was compromised.

As used in the present disclosure, (out1, out2)←SAKE(p1, in1; p2, in2) is used to denote any SAKE protocol between party p1, with private input in1 and party p2 with private input in2. The private output of party p1 is out1, whereas the private output of party p2 is out2. Further, out1 and out2 may hold the same cryptographic key if (and only if) in1 matches in2.

Broadcast Encryption.

Using a broadcast encryption (BE) scheme, a server may broadcast a message, m, encrypted in a ciphertext, ctx, to a set of clients, C, such that a sender-chosen subset of authorized clients, A⊆C, may decrypt the ciphertext, ctx, and recover the broadcasted message, m. The set A is defined at encryption time and may change for every encrypted message. For instance, A⊆C may indicate that the clients, A, are a subset of the total number of clients, C. Therefore, at encryption time of the ciphertext, the subset of clients, A, may be defined and may change based on the encrypted message. The subset of clients, A, may decrypt the ciphertext, ctx, and recover the broadcasted message, m. In the present disclosure, BE is focused on in the symmetric-key settings.

At setup time, the server draws (e.g., generates) a set of cryptographic keys, K, and distributes them among the clients (e.g., the set of clients, C), such that that a client cᵢ (e.g., a client of the set of clients, C) holds (e.g., obtains) a set of keys Kᵢ⊆K, where Kᵢ are a subset of the set of keys, K. In other words, in some variations, a client, cᵢ, might not obtain the entire set of cryptographic keys, K, but merely a subset of the keys, Kᵢ. When the server seeks to encrypt message, m, to a set of authorized clients A, the server encrypts the message, m, with a subset of the keys K_{A}⊆K ensuring that i) every client in A has at least one key in K_{A} so they can decrypt the ciphertext, and ii) no coalition of unauthorized clients in C\A can obtain any key in K_{A}. C\A may represent the group of unauthorized clients (e.g., clients not authorized to decrypt the encrypted message, m). In other words, K may represent the total number of cryptographic keys that the server generates, Kᵢ may represent a subset of keys that the client cᵢ from the list of clients, C, may obtain, and K_{A} may represent key(s) that are capable of decrypting the ciphertext to obtain the message. The server may provide the ciphertext to the clients (e.g., cᵢ as well as other clients C), and based on one or more of the client's keys, Kᵢ, including a key that is capable of decrying the ciphertext (e.g., a key from K_{A}), the client may decrypt the ciphertext to obtain the message.

In some variations, such as a trivial instantiation of BE, the server shares one unique key with each client in C. When the sender wishes to broadcast a message, m, to clients in A⊆C, it produces separate encryptions of m, each with one of the keys the sender shares with one of the clients in A. Unfortunately, this design may have a communication overhead that is linear in the number of clients in A. The communication overheard may be reduced by increasing the number of keys the server shares with each of the clients. State-of-the-art BE in the symmetric-key settings requires the server to share with each of the clients in C a number of keys proportional to the square of the logarithm of the size of C, so that the communication overhead is proportional to the number of unauthorized clients, that is, |C\A|. See, e.g., Dani Halevy, Adi Shamir: The LSD Broadcast Encryption Scheme. CRYPTO 2002 (the entire contents of which is hereby incorporated by reference herein). In practice, the sender (e.g., server) produces around |C\A|different encryptions of the message m, and each client in A can decrypt at least one of the ciphertexts, whereas no coalition of clients in C\A can decrypt any of the ciphertexts.

In the state-of-the-art, BE can define how to distribute keys, K, to clients in C and which keys to use to encrypt the message, m, given a set of authorized clients A⊆C. However, the state-of-the-art does not provide: 1) how the server draws (e.g., generates) the keys in K, nor 2) how the server defines the symmetric encryption scheme to encrypt a message given a key in K.

In the following, ctx←BE.Enc(K_{A}, m) is used to denote the encryption (“BE.Enc”) of message, m, to generate the ciphertext, ctx, using the subset of keys, K_{A}, and provide the ciphertext to an authorized set of clients, A. Similarly, m←BE.Dec(Ki, ctx) is used to denote decryption of ciphertext, ctx, by an authorized client cᵢ∈A using keys Kᵢ. cᵢ∈A represents that the client cᵢ with keys Kᵢ is part of (e.g., an element of) the set of authorized clients, A. A ciphertext may also be referred to as CTX or ctx to highlight the fact that the ciphertext is actually an ordered set of ciphertexts {ctx1, ctx2, . . . , ctxm}.

Verifiable Pseudo-Random Functions.

A pseudo-random function (PRF) may be defined by a two algorithms as follows. The first may be a key generation algorithm, which is a probabilistic algorithm that, on input a security parameter λ, produces (e.g., outputs) an evaluation key, ek. The second may be an evaluation algorithm, which accepts as input an evaluation key (e.g., ek) and an element x, and outputs an element y. In some instances, x and y are bitstrings and may be acquired via an arbitrary method. For instance, x may be determined (e.g., picked) uniformly at random from a bitstring of length 128. In some variations, a PRF ensures that, given an evaluation key as output by the key generation algorithm and a pair (x*, y*), a polynomial adversary (e.g., an unauthorized client) that does not have the evaluation key, ek, might not be able to tell (e.g., determine) whether y* is the output of the evaluation algorithm over (ek, x*) or y* is a random string. In other words, a polynomial adversary might not be able to determine whether y* is the output of the evaluation algorithm with the inputs to the evaluation algorithm being evaluation key, ek, and the element x*. As such, the element y* as output by the evaluation algorithm may be pseudo-random. This property holds even if the adversary is given polynomially-many pairs (xi, yi) where for each i, it holds that xi≠x*. For instance, an adversary may be given a list (x1, y1=F(ek, x1)), (x2, y2=F(ek, x2)), . . . , (xn, yn=F(ek, xn)). Next, the adversary obtains a “challenge” pair (x*, y*) where y* is either y*=F(ek, x*) or a random bitstring of the same length of the output of F. At this stage, the adversary must guess whether y* is the output of F or not. If x* is equal to one of the xᵢ in the list above, the adversary task is trivial. Thus, it is required that x* is different from all the xᵢ appearing in the list.

A verifiable PRF (or VRF) is a PRF with an additional algorithm (e.g., a third algorithm) that allows anybody (e.g., a client device and/or the server) to verify the alleged output of the evaluation algorithm. Compared to a PRF, the key generation algorithm of a VRF has an additional output denoted as vk and referred to as the verification key, while the evaluation algorithm has an additional output denoted as π and referred to as “proof”. The VRF also includes an additional verification algorithm (e.g., the third algorithm) that accepts as input a pair (x, y), a verification key vk, and a proof π, and outputs 1 if (ek, vk) were produced by the key generation algorithm and (y, π) were produced by the evaluation algorithm based on an input (ek, x) into the evaluation algorithm. For instance, based on inputs of (x, y), vk, and the proof π into the verification algorithm, the verification algorithm outputs “1” based on: 1) (ek, vk) being produced by the key generation algorithm; and 2) (y, π) being produced by the evaluation algorithm when (ek, x) are inputs into the evaluation algorithm.

In the following, (ek, vk)←VRF.KeyGen(λ) is used to denote the VRF key generation algorithm with (ek, vk) being outputs and λ being the security parameter input into the algorithm. (y, π)←VRF.Eval(ek, x) is used to denote the VRF evaluation algorithm with (ek, x) being inputs into the evaluation algorithm and the outputs being (y, π). Further, {0,1}←VRF.Verif(ek, x, y, π) is used to denote the verification algorithm with the inputs ek, x, y, and π as well as an output of “0” or “1” based on (ek, vk) being produced by the key generation algorithm; and 2) (y, π) being produced by the evaluation algorithm. Post-quantum VRFs based on symmetric-key cryptographic primitives are introduced in Maxime Buser, Rafael Dowsley, Muhammed F. Esgin, Shabnam Kasra Kermanshahi, Veronika Kuchta, Joseph K. Liu, Raphael Phan, Zhenfei Zhang: Post-Quantum Verifiable Random Function from Symmetric Primitives in PoS Blockchain. Cryptology ePrint Archive: Report 2021/302 (the entire contents of which are hereby incorporated by reference herein).

Anonymous SAKE (ASAKE).

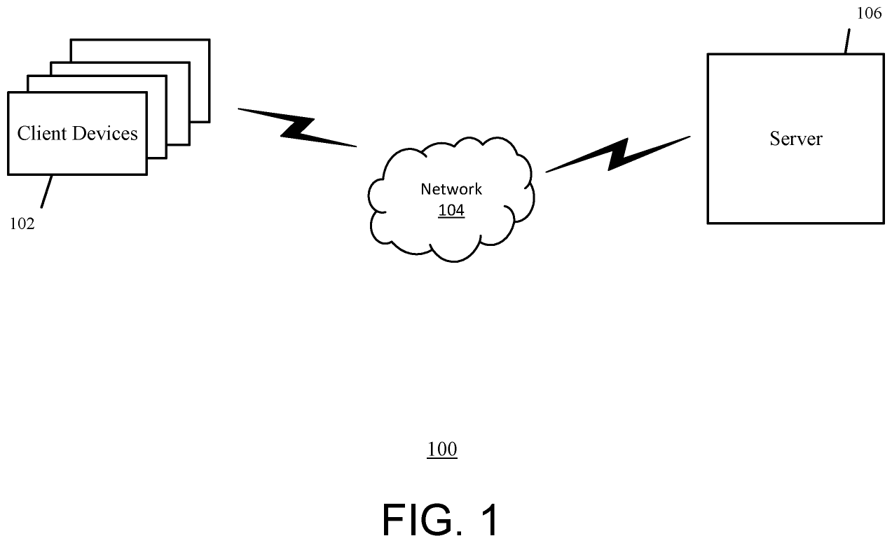

FIG. 1 illustrates a simplified block diagram depicting an exemplary computing environment 100 according to an embodiment of the present invention. The environment 100 includes a plurality of client devices 102, a network 104, and a server 106. Although certain entities within environment 100 may be described below and/or depicted in the FIGs. as being singular entities, it will be appreciated that the entities and functionalities discussed herein may be implemented by and/or include one or more entities. The ASAKE process may include one server 106 (one server, s) and a plurality of client devices 102 (e.g., an ordered set of registered clients, C={c1, . . . cn}).

The entities within the environment 100 such as the client devices 102 and the server 106 may be in communication with other devices and/or systems within the environment 100 via the network 104. The network 104 may be a global area network (GAN) such as the Internet, a wide area network (WAN), a local area network (LAN), or any other type of network or combination of networks. The network 104 may provide a wireline, wireless, or a combination of wireline and wireless communication between the entities within the environment 100.

The client devices 102 may include a set of clients C registered for the server 106. Each of the client devices 102 is and/or includes, but is not limited to, a desktop, laptop, tablet, mobile device (e.g., smartphone device, or other mobile device), smart watch, an internet of things (IOT) device, or any other type of computing device that generally comprises one or more communication components, one or more processing components, and one or more memory components.

The server 106 is a computing system that performs one or more functions described herein. The server 106 includes and/or is implemented using one or more computing devices, computing platforms, cloud computing platforms, systems, servers, and/or other apparatuses. In some instances, the server 106 and/or the client devices 102 may be implemented as engines, software functions, and/or applications. For example, the functionalities of the server 106 may be implemented as software instructions stored in storage (e.g., memory) and executed by one or more processors.

By running ASAKE, a client (e.g., one of the client devices 102) may authenticate to the server 106 and establish with the server 106 a common secret key, while at the same time keep its identity hidden among set of registered clients C (e.g., hidden among the registered clients C associated with the client devices 102). The secret key can be later used to send anonymous reports by the client to the server 106. Thus, ASAKE is relevant in a number of data-mining application scenarios where data is collected from multiple clients, including, but not limited to:
Smart metering applications: clients (e.g., client devices 102) may be smart meters that send their measurements to a server 106 hosted by the energy authority that obtains anonymous consumption measurements to forecast energy consumption.
Connected vehicle applications: clients (e.g., client devices 102) may be on board units (OBUs) installed on vehicles that send reports on, e.g., the local brake sub-system, to a server 106 hosted by the car manufacturer that collects anonymous reports to assess performance and maintenance requirement of its vehicles.
Federated learning applications: clients (e.g., client devices 102) may be mobile phones that sends model updates to a server 106 run by the phone/operating system (OS) manufacturer that coordinates a federated learning application with the goal of improving the speech recognition or the text prediction functionality of the phones.

A basic idea is to run a SAKE protocol between the server and an anonymous party claiming to be a registered client, by using a server-chosen ephemeral secret, x. The server-chosen ephemeral secret x may be a value that is used only once. In this scenario, x may be chosen fresh at every protocol run. The ephemeral secret x may be retrieved by the alleged client (e.g., by a client device 102) only if this is among the set of registered clients. In particular, the server 106 uses BE to send an encryption of x to the registered clients (e.g., the client devices 102) and to ensure that only a registered client can recover x. Once x is known by the client (e.g., by a client device 102) and the server 106, they can simply run any SAKE protocol to agree on a symmetric key.

Note that BE encryption produces a set of ciphertexts so that a registered client can decrypt one of them. An honest server encrypts the same ephemeral secret x in all ciphertexts. However, a malicious server may encrypt different ephemeral secrets in different ciphertexts in order to de-anonymize the client based on the ephemeral secret the client (e.g., the client device 102) decrypts. Thus, the present disclosure adds to the protocol a mechanism for the client (e.g., the client device 102) to verify that all BE ciphertexts sent by the server 106 encrypt the same message. This is achieved by defining the BE encryption keys as evaluation keys of a VRF. The VRF is used to produce a stream of pseudo-random bits that, in turn, is used to encrypt the ephemeral secret, x. Once the client decrypts one of the ciphertexts and recovers the ephemeral secret, it can use the verifiability property of the VRF to check that all BE ciphertexts sent by the server encrypt the same ephemeral secret. This will be described below.

Setup

The server 106 initially defines a VRF and a BE where the set of registered clients is C={c₁, . . . cₙ}. In other words, the client devices 102 include the set of registered clients C, which includes a plurality of clients from c₁, . . . cₙ. Hence, the server 106 computes (e.g., generates) a set of keys K, and gives (e.g., provides) to each client cᵢ, from the set of registered clients C, a set of keys Kᵢ⊆K, according to the BE scheme in use. In other words, the server 106 provides to each client one or more keys Kᵢ that are a subset of the entire set of keys K that the server 106 computes.

In the following, it is shown how the server 106 computes the keys in K. In particular, each key k∈K is computed as the evaluation key of a VRF, where k is an element of the set of keys, K. Let K be of size t. In order to draw (e.g., generate) the keys in K, the server 106 acts and/or performs the following:

```
K=Ø
VK=Ø
For i=1,...,t:
  (ekᵢ, vkᵢ)←VRF.KeyGen(λ)
  K←K∪{ekᵢ}
  VK←VK∪{vkᵢ}
```

For instance, initially, the keys, K, (e.g., the evaluation keys) and the verification keys (vk) are empty sets. Then, the server 106 performs one or more functions to generate each of the evaluation keys, K, a number of times based on the size, t, of K (e.g., if t is 6, then the server 106 generates 6 evaluation keys). For instance, the server 106 performs a VRF key generation algorithm using the security parameter λ to generate (e.g., output) an evaluation key ekᵢ and a verification key vkᵢ. Then, the server 106 determines the keys K based on the generated evaluation keys (e.g., K is the union of the evaluation keys, ekᵢ). The server 106 also determines the verification keys based on the generated verification keys (e.g., VK is the union of vkᵢ).

The keys in K (e.g., encryption keys) are distributed among the clients according to the BE scheme in use, whereas the keys in VK are made public. For instance, the server 106 may distribute one or more keys from the keys K to the client devices 102. Further, the server 106 makes the verification keys, vk, public.

Furthermore, below describes how the server 106 encrypts a message m, given a set of authorized clients A⊆C (e.g., the authorized clients A within the total number of clients C) and the corresponding set of encryption keys K_{A}⊆K (e.g., the subset of keys K_{A} out of the total number of generated keys K, with K_{A} being the keys used to encrypt/decrypt the message m). In practice, for each kᵢ∈K_{A} (e.g., each key kᵢ within the subset of keys K_{A}) the server draws (e.g., generates) a random initialization vector IVᵢ (e.g., a random bitstring with the same length of the block cipher input), uses the output of the VRF with input (kᵢ, IVᵢ) as a mask (e.g., a bitmask), and computes the exclusive OR (e.g., a exclusive OR statement) of the mask with the message, m, to obtain masked message zᵢ. The ciphertext is based on the masked message zᵢ. That is, the server 106 may perform the following:

```
BE.Enc(K_{A}, m)
  CTX=Ø
  For each kᵢ⊆K_{A}:
    Parse kᵢ as ekᵢ
    Pick random IVᵢ
    (yᵢ, πᵢ)←VRF.Eval(ekᵢ, IVᵢ)
    zᵢ←m⊕yᵢ
    ctxᵢ←(IVᵢ, zᵢ, πᵢ)
    CTX=CTX∪{ctxᵢ}
```

For example, the server 106 performs the encryption of message, m, using the keys K_{A}. Initially, the ciphertext CTX is an empty set. Then, for each key, kᵢ, within the set of keys K_{A}, the server 106 performs one or more functions. For instance, the server 106 parses the key, kᵢ, as the evaluation key ekᵢ. Then, the server 106 picks (e.g., determines and/or selects) a random initialization vector IVᵢ. The server 106 then uses the VRF evaluation algorithm with the inputs being ekᵢ and IVᵢ to generate (e.g., output) the element y and the proof πᵢ. Following, the server 106 uses an exclusive OR (⊕) between the output of the VRF evaluation algorithm y and the message m to generate the masked message zᵢ. The server 106 then uses the random initialization vector IVᵢ, the masked message zᵢ, and the proof πᵢ to determine (e.g., generate) the ciphertext ctxᵢ (e.g., a part of the ordered set of ciphertexts CTX). The server 106 then generates the ciphertexts CTX based on the set of ciphertexts ctxᵢ.

A ciphertext ctx also includes the proof π output by VRF.Eval (e.g., the proof output by the VRF evaluation algorithm). In some instances, the proof might not be necessary to decrypt the ciphertext and may only be used to verify the encrypted message (e.g., the server 106 might not use the proof to generate the ciphertext).

In some examples, the above setup assumes the message m to be of the same size of the output of the VRF (e.g., element y). In other examples, longer messages may be accommodated by using encryption in counter mode.

Decryption by client cᵢ works accordingly. Given CTX and Kᵢ if cᵢ∈A (e.g., the client is part of the subset of authorized clients A), then one key in Kᵢ (e.g., the keys obtained by the client) decrypts one of the ciphertexts in CTX. Without loss of generality, assume k*∈Kᵢ (e.g., the key k* out of the keys Kᵢ) decrypts ctx*∈CTX (e.g., the ciphertext ctx* out of the ciphertexts CTX. Hence, the client cᵢ (e.g., the client device 102) parses k* as ek* (e.g., the evaluation key ek*), parses ctx* as (IV*, z*, π*), computes (y*, π*)←VRF.Eval(ek*, IV*) and outputs m←z*⊕y*. For instance, a client (e.g., client device 102) may obtain k* and determine ek* based on k*. For instance, the client may treat the i-th bit of k* as the i-th bit of ek*.

For instance, the client device 102 initially includes k* as one of its keys provided by the server 106. The client device 102 parses the key k* as the ek* and the ciphertext ctx* as (IV*, z*, π*). The client device 102 then determines (e.g., computes) y* and the proof π* based on the VRF evaluation algorithm with ek* and IV* as the inputs. The client device 102 then determines (e.g., outputs) the message m based on using an exclusive OR between the masked message z* and the output, element y*, of the evaluation algorithm.

Authentication and Key Establishment

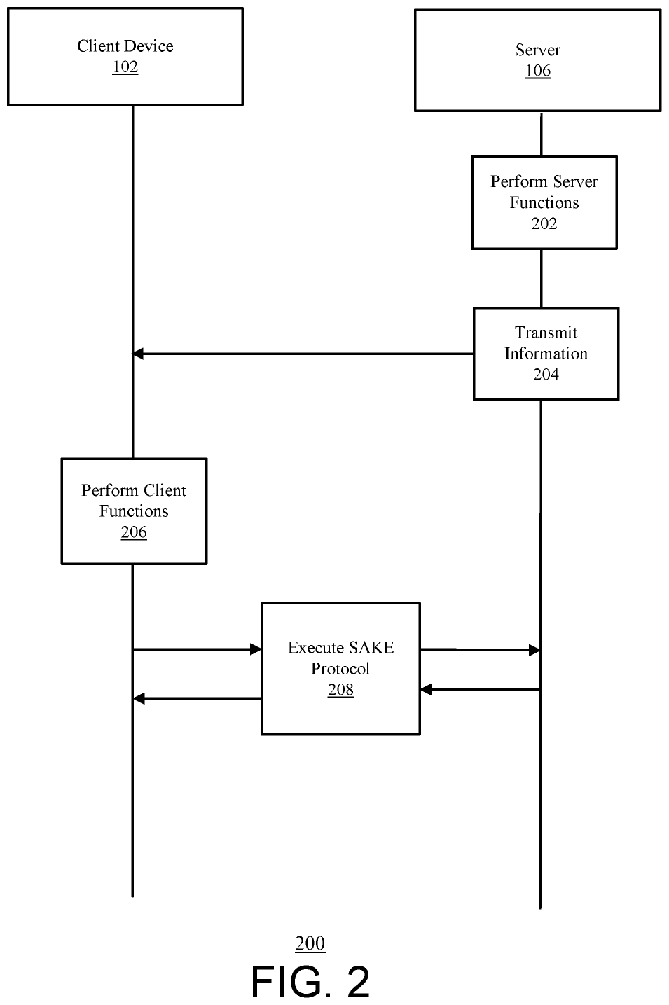

The protocol used by the server to authenticate a client and to agree on a common symmetric key is depicted in FIG. 2. For instance, FIG. 2 illustrates an event sequence for an ASAKE protocol for a server to authenticate a client and agree on a common symmetric key according to an embodiment of the present invention. FIG. 2 includes the client device 102 and the server 106 from the environment 100. The server 106 performs server functions 202, and transmits information 204. The client device 102 performs client functions 206. Then, the client device 102 and the server 106 executes a SAKE protocol 208 to ensure ASAKE (e.g., the server 106 does not know the identity of the client device 102 from the registered set of the client devices).

For example, the server 106 may determine the set of all clients C, the set of authorized clients A for the message m, the set of evaluation keys K, and the set of verification keys VK. The server 106 generating the set of evaluation keys K and the set of verification keys VK are described above. The client, c_{w}, which may be a client from the set of authorized clients A, obtains the client keys K_{w} (e.g., the set of client keys K_{w} from the set of evaluation keys K) and the set of verification keys VK, which are made public as described above. At block 202, the server 106 performs server functions. For instance, the server 106 picks (e.g., determine) a random ephemeral secret (e.g., ephemeral key or ephemeral cryptographic key), x, and uses the random ephemeral secret as the message (e.g., uses the ephemeral secret, x, as the message, m, described above). For example, the server 106 performs the encryption of message (e.g., the ephemeral secret), x, using the keys K_{A} to generate the ciphertext CTX (e.g., executes or runs CTX←BE.Enc(K_{A}, x)). This is described above. At block 204, the server 106 transmits information (e.g., the ciphertext CTX) to the client device 102.

At block 206, the client device 102 performs client functions. For instance, the client device 102 performs BE decryption to obtain the decrypted message (e.g., the decrypted ephemeral secret x′) such as by executing a BE decryption function (e.g., x′←BE.Dec(K_{w}, CTX). This is described above. Additionally, and/or alternatively, for each ciphertext ctxᵢ(e.g., a part of the ordered set of ciphertexts CTX), the client device 102 may perform the following for each ciphertext ctxᵢ to determine whether the server 106 is authentic (e.g., honest) or malicious (e.g., the protocol a mechanism for the client device 102 to verify that all BE ciphertexts were sent by the server 106). For instance, the server 106 may use the VRF verification algorithm to determine whether the server 106 is honest or malicious. For example, the client device 102 may parse the ctxᵢ as (IVᵢ, zᵢ, and the proof πᵢ). The client device 102 may perform an exclusive OR to compute yᵢ (e.g., yᵢ←zᵢ⊕x′). For instance, the client device 102 may use an exclusive OR between the masked message zᵢ and the determine ephemeral secret x′ using the BE decryption function) to determine the element yᵢ. The client device 102 may then use the VRF verification algorithm with the inputs the verification vkᵢ, random initialization vector IVᵢ, the element yᵢ, and the proof πᵢ to determine an output. For instance, the client device 102 may use the VRF verification algorithm, which is described above, to determine whether the output of the VRF verification algorithm is “0” or “1”. Based on this output, the client device 102 may determine whether to ABORT or continue with the SAKE protocol. For instance, if the output is “0” (e.g., VRF.Verify(vkᵢ, IVᵢ, yᵢπᵢ)==0), then the client device 102 aborts. In other words, the client device 102 performs the VRF verification algorithm and outputs a “1” based on 1) (ekᵢ, vkᵢ) being produced by the key generation algorithm; and 2) (yᵢ, πᵢ) being produced by the evaluation algorithm when (ekᵢ, x) are inputs into the evaluation algorithm. As such, the client device 102 may determine whether the server 106 actually generated ephemeral secret x as well as the keys ek and VK. If not (e.g., output “0”), the client device 102. If so (e.g., output “1”), the event sequence 200 moves to block 208 and the client device 102/the server 106 executes an ASAKE protocol.

At block 208, based on the output of the VRF verification algorithm being “1”, the client device 102 and the server 106 executes a SAKE (e.g., ASAKE) protocol. For instance, each party (e.g., the client device 102 and the server 106) uses a private input and each party obtains a private output. In this case, the client device 102 uses x′ that the client device 102 has just decrypted and the server 106 uses x that the server 106 has encrypted as described above. Per the SAKE protocol, if x′ equals x, then the private output of one party will match the private output of the other. This (common) private output is the final key that the two parties can now use to, e.g., encrypt their communication from now on. In other words, SAKE requires the two parties to use a private input and, if their inputs match, so will their private output. To put it another way, if x′ used as private input by the client device 102 is different from x used as private input by the server 106, the SAKE protocol will provide different outputs to the two parties.

In other words, A may be the set of clients (e.g., the client devices) allowed to authenticate. The protocol is executed by server s and an anonymous client c_{w}. Before execution starts, client c_{w} holds keys K_{w} such that K_{w}⊆K_{A}⊆K (e.g., K_{w} is from the set of keys K_{A}, which is from the set of total keys K) and the set of verification keys VK. The protocol unfolds as follows.

The server 106 picks an ephemeral secret x, runs CTX←BE.Enc(K_{A}, x) and sends CTX to c_{w} 102. Next, c_{w} 102 runs x′←BE.Dec(K_{w}, CTX).

Next, for each ctxᵢ∈CTX, the client:
parses ctxᵢ as (IVᵢ, zᵢ, πᵢ)
computes yᵢ←zᵢ⊕x′
verifies that VRF.Verify(vkᵢ, IVᵢ, yᵢ, πᵢ) outputs 1, otherwise the client aborts the execution

If the above checks complete successfully, then client c_{w} 102 with private input x′ (e.g., the decrypted ephemeral key x′) and server 106 s with private input x engage in a SAKE protocol (k′, k)←SAKE(c_{w}, x′; s, x). If x=x′ then the symmetric key k′ output by c_{w} 102 matches the symmetric key k output by the server 106.

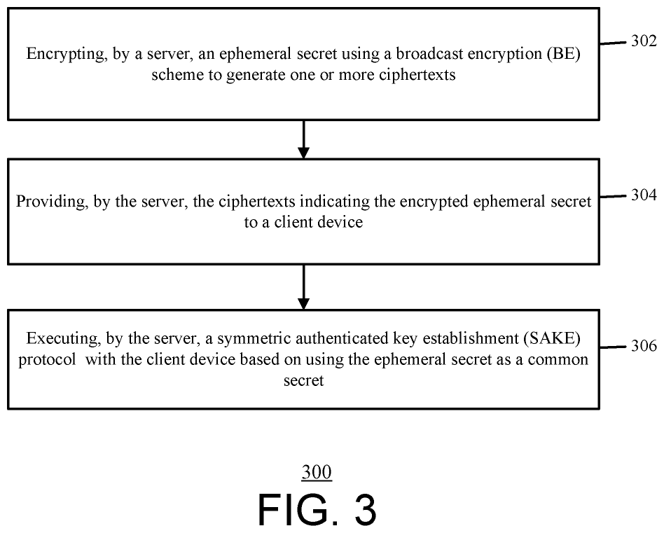

FIG. 3 illustrates a process for computing encryption keys, producing a bitmask to encrypt messages, and verify ciphertext using an ASAKE protocol according to an embodiment of the present invention. For instance, at block 302, the server 106 may encrypt an ephemeral secret using a BE scheme to generate one or more ciphertexts. At block 304, the server 106 provide the ciphertexts indicating the encrypted ephemeral secret to a client device 102. The client device 102 may decrypt one or more of the ciphertexts and verify that all of the ciphertexts are sent by the server 102. The client device 102 may then encrypt the same ephemeral secret. At block 306, the server 106 may execute a SAKE protocol with the client device 102 based on using the ephemeral secret as a common secret. Additionally, and/or alternatively, The server 106 may compute the encryption keys of a symmetric-key broadcast encryption scheme as the evaluation keys of a verifiable pseudo-random function and use the output of the verifiable pseudo-random function evaluated over random elements to produce a bitmask to encrypt messages. Then, using the proof output by the evaluation of the verifiable pseudorandom function, a ciphertext produced by the above may be verified as encrypting a given message.

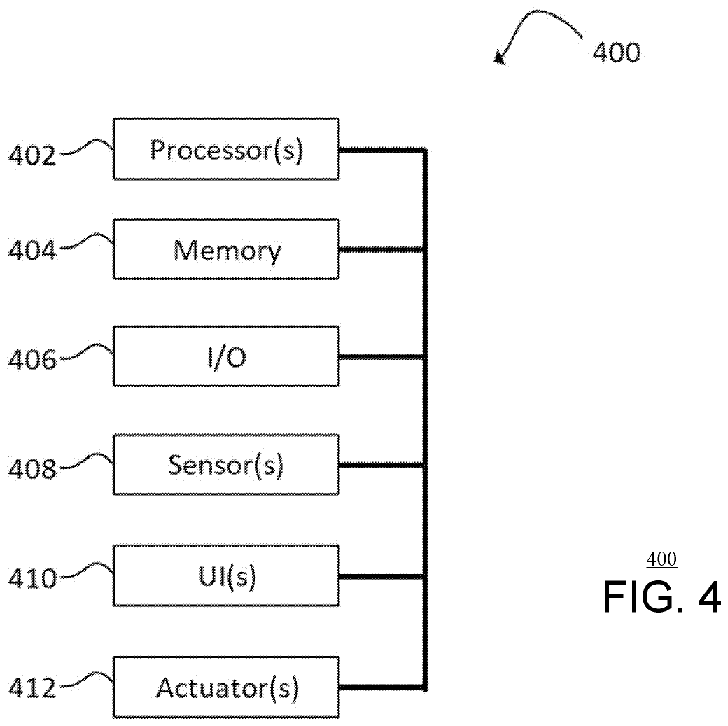

FIG. 4 is a block diagram of an exemplary processing system according to an embodiment of the present invention. Referring to FIG. 4, a processing system 400 can include one or more processors 402, memory 404, one or more input/output devices 406, one or more sensors 408, one or more user interfaces 410, and one or more actuators 412. Processing system 400 can be representative of each computing system (e.g., the client devices 102 and/or the server 106) disclosed herein.

Processors 402 can include one or more distinct processors, each having one or more cores. Each of the distinct processors can have the same or different structure. Processors 402 can include one or more central processing units (CPUs), one or more graphics processing units (GPUs), circuitry (e.g., application specific integrated circuits (ASICs)), digital signal processors (DSPs), and the like. Processors 402 can be mounted to a common substrate or to multiple different substrates.

Processors 402 are configured to perform a certain function, method, or operation (e.g., are configured to provide for performance of a function, method, or operation) at least when one of the one or more of the distinct processors is capable of performing operations embodying the function, method, or operation. Processors 402 can perform operations embodying the function, method, or operation by, for example, executing code (e.g., interpreting scripts) stored on memory 404 and/or trafficking data through one or more ASICs. Processors 402, and thus processing system 400, can be configured to perform, automatically, any and all functions, methods, and operations disclosed herein. Therefore, processing system 400 can be configured to implement any of (e.g., all of) the protocols, devices, mechanisms, systems, and methods described herein.

For example, when the present disclosure states that a method or device performs task “X” (or that task “X” is performed), such a statement should be understood to disclose that processing system 400 can be configured to perform task “X”. Processing system 400 is configured to perform a function, method, or operation at least when processors 402 are configured to do the same.

Memory 404 can include volatile memory, non-volatile memory, and any other medium capable of storing data. Each of the volatile memory, non-volatile memory, and any other type of memory can include multiple different memory devices, located at multiple distinct locations and each having a different structure. Memory 404 can include remotely hosted (e.g., cloud) storage.

Examples of memory 404 include a non-transitory computer-readable media such as RAM, ROM, flash memory, EEPROM, any kind of optical storage disk such as a DVD, a Blu-Ray® disc, magnetic storage, holographic storage, a HDD, a SSD, any medium that can be used to store program code in the form of instructions or data structures, and the like. Any and all of the methods, functions, and operations described herein can be fully embodied in the form of tangible and/or non-transitory machine-readable code (e.g., interpretable scripts) saved in memory 404.

Input-output devices 406 can include any component for trafficking data such as ports, antennas (i.e., transceivers), printed conductive paths, and the like. Input-output devices 906 can enable wired communication via USB®, DisplayPort®, HDMI®, Ethernet, and the like. Input-output devices 406 can enable electronic, optical, magnetic, and holographic, communication with suitable memory 404. Input-output devices 406 can enable wireless communication via WiFi®, Bluetooth®, cellular (e.g., LTE®, CDMA®, GSM®, WiMax®, NFC®), GPS, and the like. Input-output devices 406 can include wired and/or wireless communication pathways.

Sensors 408 can capture physical measurements of environment and report the same to processors 402. User interface 410 can include displays, physical buttons, speakers, microphones, keyboards, and the like. Actuators 412 can enable processors 402 to control mechanical forces.

Processing system 400 can be distributed. For example, some components of processing system 400 can reside in a remote hosted network service (e.g., a cloud computing environment) while other components of processing system 400 can reside in a local computing system. Processing system 400 can have a modular design where certain modules include a plurality of the features/functions shown in FIG. 4. For example, I/O modules can include volatile memory and one or more processors. As another example, individual processor modules can include read-only-memory and/or local caches.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A method for providing anonymous symmetric authenticated key establishment (ASAKE), the method comprising:
encrypting, by a server, an ephemeral secret using a broadcast encryption (BE) scheme to generate one or more ciphertexts;
providing, by the server, the ciphertexts indicating the encrypted ephemeral secret to a client device; and
executing, by the server, a symmetric authenticated key establishment protocol (SAKE) with the client device based on using the ephemeral secret as a common secret.

2. The method of claim 1, further comprising:
generating, by the server, a plurality of encryption keys based on a verifiable pseudo-random function (VRF) key generation algorithm,
wherein encrypting the ephemeral secret is based on using the plurality of encryption keys.

3. The method of claim 2, further comprising:
generating, by the server, a plurality of verification keys based on the VRF key generation algorithm, wherein a security parameter is input into the VRF key generation algorithm to generate the plurality of verification keys and the plurality of encryption keys; wherein the plurality of verification keys are made public; and
providing, by the server, a first subset of the plurality of encryption keys to the client device.

4. The method of claim 2, wherein encrypting the ephemeral secret using the BE scheme comprises:
determining, by the server, a second subset of the plurality of encryption keys based on a set of authorized client devices, wherein the set of authorized client devices comprises the client device;
determining, by the server, one or more random initialization vectors; and
encrypting the ephemeral secret using the second subset of the plurality of encryption keys and the one or more random initialization vectors.

5. The method of claim 4, wherein encrypting the ephemeral secret using the second subset of the plurality of encryption keys and the one or more random initialization vectors comprises:
inputting the second subset of the plurality of encryption keys and the one or more random initialization vectors into a VRF evaluation algorithm to determine an output of the VRF evaluation algorithm and a proof of the VRF evaluation algorithm; and
generating the ciphertexts indicating the encrypted ephemeral secret based on using a bitmask and the output of the VRF evaluation algorithm.

6. The method of claim 5, wherein generating the ciphertexts using the bitmask and the output of the VRF evaluation algorithm comprises:
using an exclusive OR statement for the ephemeral secret and the output of the VRF evaluation algorithm to generate the encrypted ephemeral secret.

7. The method of claim 5, wherein the ciphertexts comprises the encrypted ephemeral secret, the one or more random initialization vectors, and the proof of the VRF evaluation algorithm.

8. The method of claim 1, further comprising:
decrypting, by the client device, a ciphertext of the ciphertexts to determine the ephemeral secret, wherein the ciphertexts comprises the encrypted ephemeral secret, one or more random initialization vectors, and a server proof of an VRF evaluation algorithm;
verifying, by the client device, that the ciphertexts are sent by the server; and
encrypting, by the client device, the ephemeral secret determined from the ciphertexts.

9. The method of claim 8, wherein decrypting the one or more of the ciphertexts to determine the ephemeral secret comprises:
inputting an evaluation key, of a plurality of evaluation keys provided by the server, and a random initialization vector, of the one or more random initialization vectors, into the VRF evaluation algorithm to determine a client device proof of the VRF evaluation algorithm and an output of the VRF evaluation algorithm; and
decrypting the encrypted ephemeral secret based on the ciphertext and the output of the VRF evaluation algorithm.

10. The method of claim 9, wherein decrypting the encrypted ephemeral secret is based on using an exclusive OR statement for the output of the VRF evaluation algorithm and encrypted ephemeral secret.

11. The method of claim 8, wherein verifying that the ciphertexts are sent by the server comprises:
determining an output of the VRF evaluation algorithm based on using an exclusive OR statement for the ephemeral secret decrypted from the ciphertext and the encrypted ephemeral secret from the ciphertexts.

12. The method of claim 11, wherein verifying that the ciphertexts are sent by the server further comprises:
inputting a verification key generated by the server, the random initialization vector, the output of the VRF evaluation algorithm, and the client device proof of the VRF evaluation algorithm into a VRF verification algorithm to determine a verification output of the VRF verification algorithm, and
wherein executing the SAKE protocol between the server and the client device is based on the verification output.

13. A system, comprising:
a server configured to:
encrypt an ephemeral secret using a broadcast encryption (BE) scheme to generate one or more ciphertexts;
provide the ciphertexts indicating the encrypted ephemeral secret to a client device; and
execute a symmetric authenticated key establishment protocol (SAKE) with the client device based on using the ephemeral secret as a common secret.

14. The system of claim 13, further comprising:
the client device, configured to:
decrypt a ciphertext of the ciphertexts to determine the ephemeral secret, wherein the ciphertexts comprises the encrypted ephemeral secret, one or more random initialization vectors, and a server proof of an VRF evaluation algorithm;
verify that the ciphertexts are sent by the server; and
encrypt the ephemeral secret determined from the ciphertexts.

15. A tangible, non-transitory computer-readable medium having instructions thereon which, upon being executed by one or more hardware processors, alone or in combination, provide for execution of a method comprising:
encrypting an ephemeral secret using a broadcast encryption (BE) scheme to generate one or more ciphertexts;
providing the ciphertexts indicating the encrypted ephemeral secret to a client device; and
executing a symmetric authenticated key establishment protocol (SAKE) with the client device based on using the ephemeral secret as a common secret.
